(19) United States
(12) Patent Application Publication
(10) Pub. No.: US 2026/0183182 A1
(43) Pub. Date: Jul. 2, 2026

(54) PULSE PENIS

(71) Applicant: KISSKY (HK) LIMITED, HONG KONG (HK)

(72) Inventor: Dewei LUO, HONG KONG (HK)

(73) Assignee: KISSKY (HK) LIMITED, HONG KONG (HK)

(21) Appl. No.: 19/006,096

(22) Filed: Dec. 30, 2024

(51) Int. Cl. A61H 19/00; A61H 23/02

(52) U.S. Cl. CPC A61H 19/44; A61H 23/0263; A61H 2023/0272; A61H 2023/0281; A61H 2201/0153; A61H 2201/0207; A61H 2201/0228; A61H 2201/1215; A61H 2201/5005

(57) ABSTRACT

The present application provides a pulse penis, including a shell, a first pulse assembly, and a second pulse assembly. The first pulse assembly includes a first motor arranged in an accommodating cavity. The second pulse assembly includes a second motor arranged in the accommodating cavity. The second motor is arranged behind the first motor in a length direction of the shell. An axis of the first motor and an axis of the second motor are located on a same straight line in the length direction of the shell, and the first motor and the second motor operate alternately.

The pulse penis generates continuous pulse vibrations with percussive changes in the length direction of the shell as the coaxial double motors operate alternately.

This pulse effect can effectively simulate the natural rhythm in a true physiological response.

### BACKGROUND

### 1. Technical Field

The present application relates to the field of sex toys, and particularly relates to a pulse penis.

### 2. Background Information

With increasing concern on sexual health and individual demands in the society, sex toys, as an assistant tool, have become an important means to improve the quality of sexual life, alleviate the sexual stress, and meet the individual demands. With popularization of the sexual health concept, various sex toys rich in function and innovative in design emerge on the market. These products not only meet the basic physiological needs, but also are innovated in design and function, to provide more real and comfortable using experience.

Most existing sex toys are driven by vibration, rotation, and the like, and provide stimulation of different forms through a built-in electric motor or other mechanical assemblies. A common working principle includes a single vibrating mode, variable speed vibration, and the like. These products usually simulate different physiological responses by adjusting the rotating speed, direction or frequency of a motor. For example, some high-end sex toys are equipped with a plurality of motors to adjust the vibrating intensity and frequency or realize different using experience through a plurality of vibrating modes.

However, existing sex toys have some defects in simulating the real sexual experience. Although various vibrating modes are used, they still hardly simulate the real physiological responses effectively, and a plurality of driving assemblies are arranged, which results in inharmonious vibration. The strength and frequency changes of stimulation may make the user feel uncomfortable or unnatural in experience, which affects the overall using experience. This abrupt change makes existing products unable to fully meet the demand of the user on smoother, coherent, and real experience. Therefore, it is necessary to provide a sex toy capable of better providing a user with more real and natural behaviors, to solve the above problems.

### BRIEF SUMMARY

In view of this, it is necessary to provide a sex toy capable of better providing a user with more real and natural behaviors, to solve the above problems.

An embodiment of the present application provides a pulse penis, including:
a shell, provided with an accommodating cavity in a length direction thereof;
a first pulse assembly, comprising a first motor arranged in the accommodating cavity, and a first eccentric block and a second eccentric block that are arranged on two opposite sides of the first motor; and
a second pulse assembly, including a second motor arranged in the accommodating cavity and a third eccentric block arranged on the second motor, where the second motor is arranged behind the first motor in the length direction of the shell, and when the pulse penis is used, the first pulse assembly and the second pulse assembly operate alternately;
where an axis of the first motor and an axis of the second motor are located on a same straight line in the length direction of the shell.

The above provided pulse penis generates continuous pulse vibrations with percussive changes in the length direction of the shell as the first motor and the second motor operate alternately. This pulse effect can effectively simulate the natural rhythm in the real physiological responses. The first motor and the second motor are coaxially arranged to ensure the consistency of the vibrating direction, so that the vibration is transitioned more smoothly in the process of alternate operation. Therefore, the unnatural feeling caused by abrupt vibration in a conventional sex toy is avoided. Due to the natural change of the pulse intensity, the vibration is more coherent and real, meeting the perceptual rule of a human body.

### BRIEF DESCRIPTION OF THE DRAWINGS

FIG. 1 is a stereogram of a pulse penis in an embodiment of the present application.

FIG. 2 is a cross-section diagram of the pulse penis in FIG. 1.

FIG. 3 is a partially exploded view of the pulse penis in FIG. 1.

FIG. 4 is a three-dimensional enlarged exploded view of the pulse penis in FIG. 1.

FIG. 5 is a three-dimensional exploded cross-section diagram of the pulse penis in FIG. 1.

FIG. 6 is a three-dimensional exploded view of the pulse penis in FIG. 1.

### DESCRIPTION OF SYMBOLS OF MAIN COMPONENTS

100, pulse penis; 10, shell; 11, accommodating cavity; 111, vibrating cavity; 112, electrical cavity; 12, stimulating portion; 13, holding portion; 14, fixed block; 141, first fixed groove; 141a, first cavity; 141b, second cavity; 141c, third cavity; 141d, first straight slot; 142, second fixed groove; 142a, fourth cavity; 142b, fifth cavity; 15, first division plate; 16, cable cavity; 17, second division plate; 20, first pulse assembly; 21, first motor; 22, first eccentric block; 23, second eccentric block; 30, second pulse assembly; 31, second motor; 32, third eccentric block; 40, connector; 41, cable duct; 50, power supply assembly; 60, fixed base; 70, control assembly; 71, control panel; 72, stepless adjusting device; 80, heating film.

### DETAILED DESCRIPTION OF THE DRAWINGS AND THE PRESENTLY PREFERRED EMBODIMENTS

A description will be made on the technical solution in the embodiment of the present application below in combination with drawings in the embodiment of the present application. It is apparent that the described embodiments are merely a part of embodiments of the present application and are not all the embodiments.

It should be noted that when one assembly is regarded as being connected with another assembly, the assembly can be directly connected to another assembly or an assembly arranged in the center may exist as well. When one assembly is regarded as being arranged on another assembly, the assembly may be directly arranged on another assembly or an assembly arranged in the center may exist as well. The terms “top”, “bottom”, “upper”, “lower”, “left”, “right”, “front”, “back”, and similar expressions used herein are merely for description purposes.

An embodiment of the present application provides a pulse penis, including:
a shell, provided with an accommodating cavity in a length direction thereof;
a first pulse assembly, including a first motor arranged in the accommodating cavity, and a first eccentric block and a second eccentric block that are arranged on two opposite sides of the first motor; and
a second pulse assembly, including a second motor arranged in the accommodating cavity and a third eccentric block arranged on the second motor, where the second motor is arranged behind the first motor in the length direction of the shell, and when the pulse penis is used, the first pulse assembly and the second pulse assembly operate alternately;
where an axis of the first motor and an axis of the second motor are located on a same straight line in the length direction of the shell.

The above provided pulse penis generates continuous pulse vibrations with percussive changes in the length direction of the shell as the first motor and the second motor operate alternately. This pulse effect can effectively simulate the natural rhythm in the real physiological responses. The first motor and the second motor are coaxially arranged to ensure the consistency of the vibrating direction, so that the vibration is transitioned more smoothly in the process of alternate operation. Therefore, the unnatural feeling caused by abrupt vibration in a conventional sex toy is avoided. Due to the natural change of the pulse intensity, the vibration is more coherent and real, meeting the perceptual rule of a human body.

Embodiments of the present application will be described in detail below in combination with drawings. In the absence of conflict, the embodiments and features in the embodiments can be combined with one another.

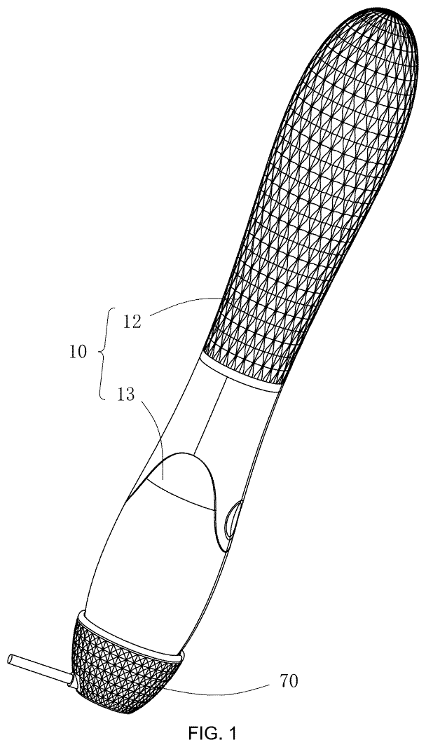

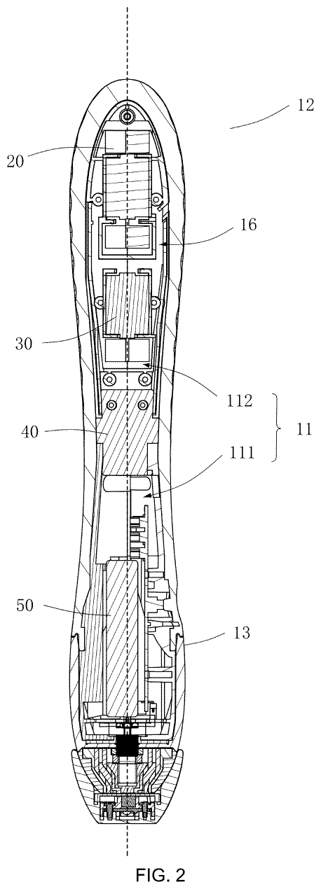

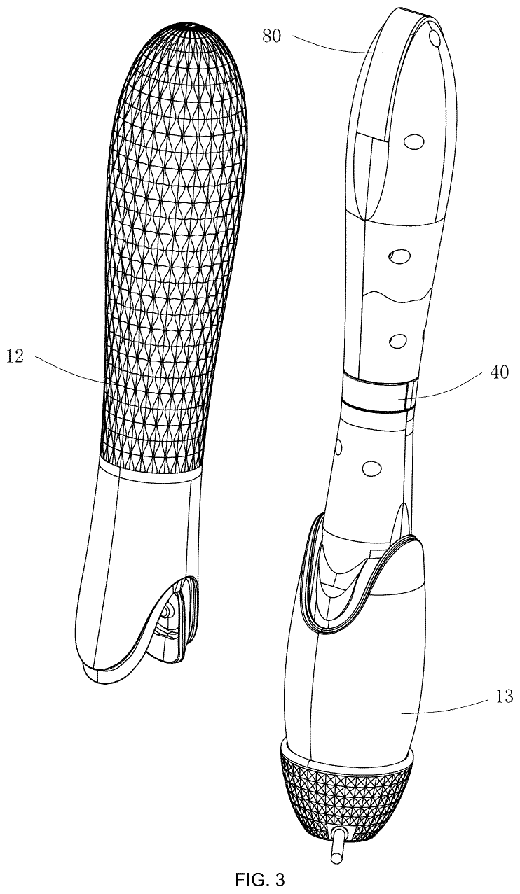

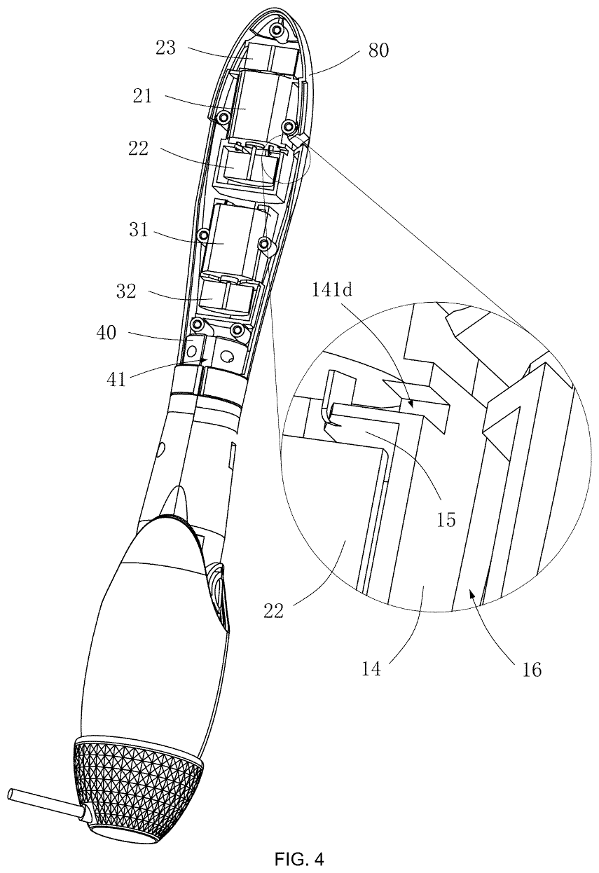

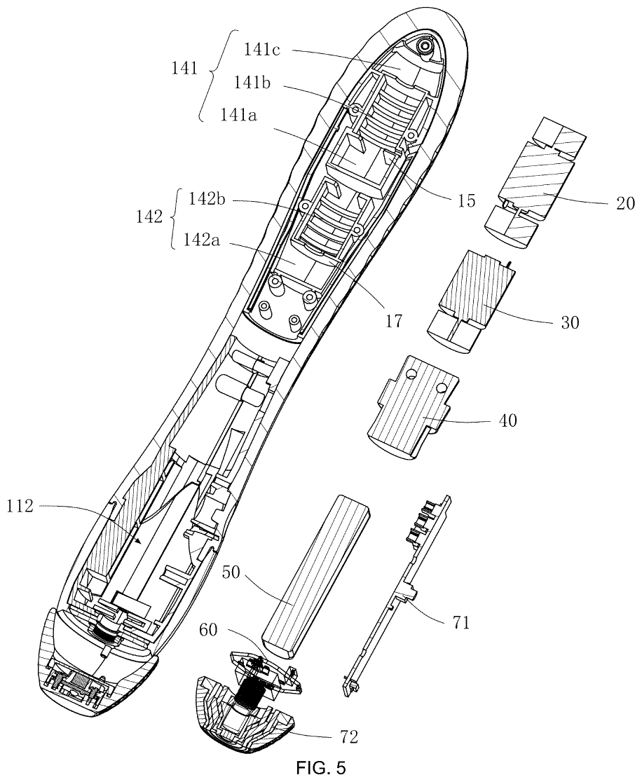

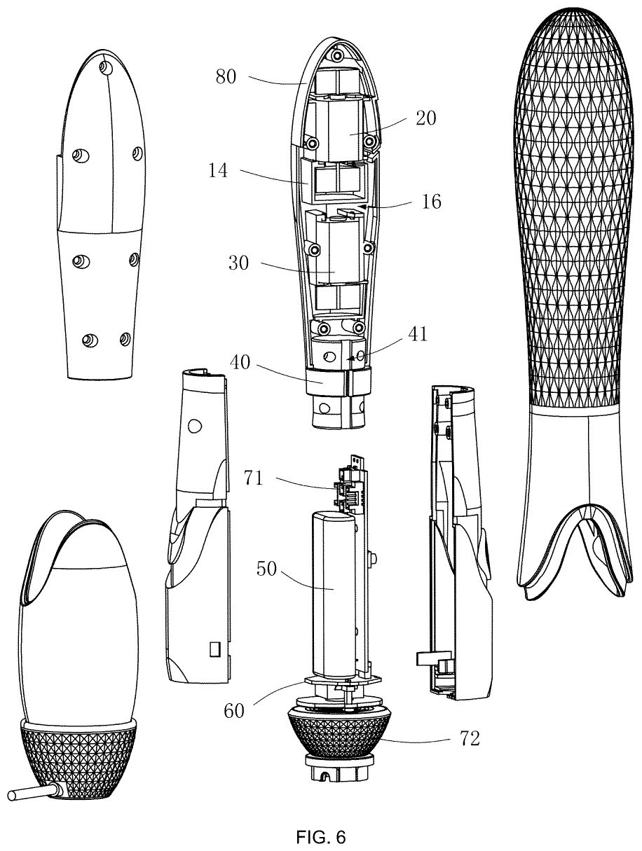

Referring to FIGS. 1-6, an embodiment of the present application provides a pulse penis 100, including:
a shell 10, provided with an accommodating cavity 11 in a length direction thereof;
a first pulse assembly, including a first motor 21 arranged in the accommodating cavity 11, and a first eccentric block 22 and a second eccentric block 23 that are arranged on two opposite sides of the first motor 21; and
a second pulse assembly, including a second motor 31 arranged in the accommodating cavity 11 and a third eccentric block 32 arranged on the second motor 31, where the second motor 31 is arranged behind the first motor 21 in the length direction of the shell 10, and when the pulse penis is used, the first pulse assembly and the second pulse assembly operate alternately;
where an axis of the first motor 21 and an axis of the second motor 31 are located on a same straight line in the length direction of the shell 10.

Specifically, the shell 10 is a core structure of a device, providing mechanical protection and functional support. The accommodating cavity 11 is configured to accommodate internal assemblies and fix them at specific positions. The first motor 21 drives the first eccentric block 22 and the second eccentric block 23 to rotate synchronously to generate a stable and continuous vibratory force, as a basic output portion of vibration. The second motor 31 provides the vibratory force through the rotation of the single eccentric block to form a double power structure wherein the second motor and the first pulse assembly are distributed front and back. The motors arranged front and back operate alternately, so that the vibratory force is outputted intermittently and directionally. By alternately activating operations of different assemblies, a real rhythmed stimulation is simulated.

Further, the axes are aligned, so that the acting directions of the two vibratory forces are consistent, and therefore, the force is efficiently transferred and the directionality and stability of pulse waves are ensured. The unnatural and abrupt using experience caused by deviation of the axes is reduced, and the coaxial arrangement may reduce the vibrating interference or energy loss, and improve the pulse effect. The first pulse assembly and the second pulse assembly are started and stopped alternately in time, so as to generate rhythmed pulse vibrations at the output end of the device, rather than non-pure continuous vibrations. This pulse vibration can make the human body feel the impact force of the pulse penis in the using direction, and the pulse penis can generate more real and natural physiological effect during use.

Further, the user starts the device, and the first motor and the second motor 31 enter a standby state to prepare for alternate operations according to a program. The first motor 21 is started to drive the first eccentric block and the second eccentric block 23 to rotate, so as to generate a vibratory force on the front portion. The first motor 21 is stopped, and the second motor 31 is started. The second motor 31 drives the third eccentric block 32 to rotate to generate a vibratory force on the back portion. The two motors are alternately started according to a set time interval to output rhythmed vibration waves. Since the vibratory forces during the operation of the front and back motors are intermittent, this alternate operation is manifested as an intermittent vibration in one direction on the housing of the device to form mechanical waves similar to sinusoidal pulses.

In a specific embodiment, the shell 10 includes a plurality of fixed blocks 14,
the plurality of fixed blocks 14 are arranged on an inner surface of the shell 10 to enclose a first fixed groove 141 and a second fixed groove 142, the first fixed groove 141 and the second fixed groove 142 are formed in a spaced manner in the length direction of the pulse penis, the first fixed groove 141 fixes the first pulse assembly 20, and the second fixed groove 142 fixes the second pulse assembly 30.

Specifically, the plurality of fixed blocks 14 are arranged on the inner surface of the shell 10, so that the stability of the overall structure is significantly improved. These fixed blocks 14 can firmly position the driving assembly in the operating process of the device and prevent assemblies from being loosened or displaced due to external vibrations or impact during use, so that the service life of the device is effectively prolonged and the operating stability of the device is effectively improved. Moreover, the design of the fixed blocks 14 and the fixed groove ensures that the first pulse assembly and the second pulse assembly 30 are precisely positioned in the shell 10, so that deviation or dissymmetry caused by an inharmonious movement is avoided.

Further, the fixed grooves are formed in a spaced manner in the length direction of the shell 10, so that the two driving assemblies can be isolated physically to avoid mutual interference. According to this spaced design, each driving assembly can operate independently, and the transfer path of the vibration is further optimized, so that the energy loss and the vibratory pulse are reduced. Through this physical isolation and precise positioning, the vibration performance of the first pulse assembly and the second pulse assembly 30 can be exerted fully, so that the pulse vibration effect is more harmonious. Moreover, an unstable phenomenon caused by differences in running characteristics of different assemblies is avoided, so that the overall performance of the device and the user experience are improved.

In a specific embodiment, the shell 10 further includes a first division plate 15, the first division plate 15 being arranged in the first fixed groove 141 and dividing the first fixed groove 141 into a first cavity 141a and a second cavity 141b;
one side of the first fixed groove 141 close to a massage end and the shell 10 enclose a third cavity 141c, the first cavity 141a, the second cavity 141b, and the third cavity 141c are parallelly formed in sequence, and the first motor 21 is arranged in the second cavity 141b.

Specifically, the first division plate 15 is arranged to divide the interior of the fixed groove into a plurality of independent cavities, so that assemblies with different functions can be effectively separated, and mutual interference of the assemblies is avoided. One side of the fixed groove close to the massage end and the shell 10 enclose an independent cavity. According to this separated design, the eccentric block and the motor are respectively located in different cavities, so that the independence of the two in movement and vibration is ensured. The eccentric block is prevented from colliding or rubbing with other assemblies during high-speed rotation, so that the interference, wear, and noise problems are reduced. Particularly in the case of long-term use or high-frequency vibration of the device, this design reduces the mutual wear among the components, reduces the maintenance need, and improves the durability of the device.

Further, the eccentric block, the motor, and other assembles are divided into independent space as the cavities are formed parallelly, so that the mechanical and electrical interference is effectively reduced. The separated design optimizes the smoothness of vibration transfer, so that the device operates more stably, the vibration effect is more uniform, and the stability of the device is significantly improved and the service life of the device is significantly prolonged.

In a specific embodiment, the shell 10 is further provided with a cable cavity 16, the plurality of fixed blocks 14 and the shell 10 enclosing the cable cavity 16; and
a first through slot 141d is formed in a side wall of the first fixed groove 141, the first through slot 141d communicates the second cavity 141b with the cable cavity 16, and the cable cavity 16 is configured to fix cables.

Specifically, the arrangement of the fixed groove not only provides a stable fixing effect to the driving assembly, but also jointly forms an independent cable cavity 16 structure with the side wall of the shell 10. According to this design, the cable cavity 16 and the fixed groove are kept relatively independent, so that the mutual interference between cable wiring and driving assembly fixing is avoided. The arrangement of the cable cavity 16 improves the layout efficiency of cables and further provides a stable supporting environment for the cables to prevent the cables from being loosened or worn due to an external force or vibration, so that the stability of the overall structure of the device is improved. The isolated design between the vibrating component and the cable cavity 16 further protects the cables, thereby avoiding wear of the cables and the problem of electrical connection failure caused thereby.

Further, the cable cavity 16 is arranged to not only provide controlled fixed space for the cables, but also effectively protect the cables and connecting points thereof through mechanical vibrations generated by the driving assemblies working for a long time. In the cable cavity 16, the cables are arranged in a controlled manner and are hardly displaced due to vibrations, so that the risk of looseness, poor contact or breakage of welding spots due to the vibrations is reduced, and the durability and reliability of the device are significantly improved.

Further, the straight slot is designed to explore an independent wiring path for the cables, so that the cables are separated from the moving area of the eccentric block, and the cables are prevented from being interfered with due to a dynamic action. The existence of the straight slot ensures that the cables can be stably connected to the motor, so that the risk of looseness or fall of the connections due to stress is avoided. This optimized cable management design not only improves the operating stability of the device, but also prolongs the service lives of key components, ensuring that the device still can operate reliably in a high-frequency vibrating condition.

In a specific embodiment, the shell 10 is further provided with a cable cavity 16, the plurality of fixed blocks 14 and the shell 10 enclosing the cable cavity 16; and
a first through slot 141d is formed in a side wall of the first fixed groove 141, the first through slot 141d communicates the second cavity 141b with the cable cavity 16, and the cable cavity 16 is configured to fix cables.

Specifically, the second division plate 17 is arranged to separate the fixed grooves, and the eccentric blocks and the motors are separately placed in independent cavities, which effectively prevents interference with other assemblies such as motors by the vibrations generated by high-speed operation of the eccentric blocks. This separated design not only reduces the mechanical interference among internal components, but also reduces wear and failure risks caused by contact or resonance, so that the reliability of the device is improved and the service life of the device is prolonged.

Further, the isolated cavities are connected to the cable cavity 16 to provide independent and stable paths for the electrical connections of the motors. This design effectively isolates a direct influence of the vibrations on the cables to ensure the reliability of the electrical connections, thereby avoiding the problem of unstable electrical performance caused by the vibrations or long-term use. Through the combined design of the division plate and the cable cavity 16, the electrical and mechanical portions are clearly distinguished, so that when the device operates, the mechanical vibrations and the electrical performance are kept stable, and therefore, the operating effect and durability of the whole device are further improved.

In a specific embodiment, the shell 10 includes a holding portion 13 and a stimulating portion 12 arranged in sequence in the length direction thereof, and the pulse penis further includes a connecting piece 40 arranged between the holding portion 13 and the stimulating portion 12;
the connecting piece 40 divides the accommodating cavity 11 to form an electrical cavity 112 and a vibrating cavity 111, the connecting piece 40 is provided with a cable duct 41, the cable duct 41 communicates the electrical cavity 112 with the vibrating cavity 111, and the cable duct 41 and the shell 10 enclose a fixed channel to prevent the cables from deviating.

Specifically, by dividing the internal structure of the connector 40 into the electrical cavity 112 and the vibrating cavity 111, the electrical assembly and the vibrating assembly are regionally isolated. This design avoids direct interference with the electrical assembly when the vibrating assembly operates, so as to improve the stability of overall operation and the electrical performance of the device. The electrical assembly and the vibrating assembly operate independently to effectively reduce an influence of resonance on sensitive components and reduce the failure risk of the device caused by mutual interference among components.

Further, the cable duct 41 is arranged to provide an independent and safe channel for arranging the cables between the electrical cavity 112 and the vibrating cavity 111. The cable duct 41 can fix the cables at appointed positions to prevent displacement of the cables or unnecessary dragging and wear problems caused by the vibrations in the long-term operating process of the device. Protected by the cable dust 41, the stress of the cables at the connections is uniformly distributed to reduce the breaking or loosening probability, so that the service life of the device is prolonged and the operating safety and stability of the device are ensured.

In a specific embodiment, the pulse penis further includes a power supply assembly 50, the power supply assembly 50 being arranged in the electrical cavity 112 and electrically connected to the first motor 21 and the second motor 31 to supply power to the pulse penis.

Specifically, the power supply assembly 50 is mounted in a centralized manner in the electrical cavity 112 and is physically isolated from the vibrating cavity 111. This structural design avoids an influence on a power supply system in the operating process of the vibrating assembly, ensuring the power supply stability and reliability of the device. By clearly dividing the independent space of the power supply assembly 50, the spatial utilization ratio inside the device is optimized, and the wire arrangement is further reasonable, so that the probability of cross interference is reduced.

Further, the power supply assembly 50 provides the driving assembly with constant and reliable power supply through the precise electrical connections, ensuring that the driving assembly can be seamlessly switched in different working conditions without power supply interruption or hysteresis. Thanks to a constant power output, the device can be kept at a stable vibrating strength in the operating process, and the consistency and uniformity of the pulse effect are guaranteed. This optimized power supply design greatly improves the performance of the device in the high-frequency vibrating state.

In a specific embodiment, the shell 10 further includes a fixed base 60, the fixed base 60 being arranged at a bottom of the electrical cavity 112 and fixedly connected to the shell 10, and the power supply assembly 50 being arranged on the fixed base 60.

Specifically, the fixed base provides the power supply assembly 50 with a stable supporting structure, which effectively bears and specifies the mounting position of the power supply assembly 50, so that the layout of the power supply assembly is well structured. Through stable support of the base, the power supply assembly 50 can be kept in a fixed state in the operating process to avoid displacement or looseness generated by the vibrations of the device, so that the safety and operating reliability of the device are greatly improved.

Further, the power supply assembly 50 is installed in a centralized at the bottom, which not only saves the effective space in the device, but also optimizes the overall utilization ratio of the electrical cavity 112. The fixed base is close to the bottom of the electrical cavity 112 and can work cooperatively with a heat dissipating structure to help the power supply assembly 50 dissipate heat more efficiently, thereby further prolonging the service life of the device. Moreover, the base and the shell 10 are connected to form an integrated supporting structure, which not only enhances the overall strength of the shell 10, but also provides a guarantee to long-term stable operation of the device.

In a specific embodiment, the pulse penis further includes a control assembly 70,
where the control assembly 70 includes a control panel 71 and a stepless adjusting device 72 electrically connected to the control panel 71, the control panel 71 being arranged on the fixed base 60 and electrically connected to the power supply assembly 50; and
the stepless adjusting device 72 is arranged on one side of the fixed base 60 away from the control panel 71 and is rotationally connected to the fixed base 60 to adjust power of the first pulse assembly 20 and the second pulse assembly 30.

Specifically, the control panel 71 is integrated on the fixed base 60, and the internal layout of the device is optimized, so that the overall assembly and wiring are more concise and efficient. The control panel 71 is directly connected to the power supply assembly 50, which ensures that a control signal is stable and reliable in a transmission process and reduces the complexity of a circuit design. The stepless adjusting device 72 is reasonably arranged on the back side of the control panel 71, which avoids the congestion of a control region, so that the device is more intuitively and conveniently operated. Through the rotational connection design, the user can perform rotation regulation smoothly, keep a comfortable hand feeling while adjusting the power, and is good in operating experience.

Further, a stepless adjusting variable-speed control system outputs a PWM (PWM is a technology for modulating the width of a series of pulses, which equivalently obtains required waveforms by changing the width of the pulses) signal to control the motors through a program; the program detects an input of an encoder to judge the rotating direction of the encoder, and the program specifically changes the duty cycle (the signal consists of a high level and a low level, and the motor output is controlled by adjusting the time proportion of the high level) according to the rotating direction to control a variable-speed output; and by detecting the input of the encoder, the program realizes the stepless variable-speed control of the motors by adjusting the output of the duty cycle.

In a specific embodiment, the pulse penis further includes a heating film 80, the heating film 80 being arranged at one end of the stimulating portion 12 facing away from the holding portion 13 to perform heating during use.

Specifically, the heating film 80 is a thin and flexible heating element, which is usually made of a metal film, a resistance material, or conductive ink. The heating film plays a role of converting electric energy into heat energy after electrification, so as to provide a continuous and stable heating effect to the device. By arranging the heating film 80 at the tail end of the stimulating portion 12, it is ensured that heat is mainly acted on skin or target regions, so that the heat stimulating effect is improved. Heat stimulation combined with vibration to bring multiple sense judgment, so that the overall functionality of the device is improved. The heating function can simulate the natural temperature of the human body, creating a real and comfortable touch.

Further, the shell 10 is provided with a control button in data connection to the control panel 71. The control button is long-pressed to input through a program detection button. When detecting that a switch is long-pressed to be valid, it enters a working mode, and the motor output is controlled through the PWM; in the corresponding working mode, the program controls a heating device to realize a constant temperature output through NTC temperature detection; the program detection button is short-pressed to input; when detecting that the switch is short-press to be valid, it is cyclically switched to work, and the rotating speed and rotating mode of the motor in the corresponding mode are switched; the program detection button is long-pressed to input to enter a shutdown mode from the working mode, and the program stores the corresponding working mode; and in each working mode, the motor can be subjected to stepless variable speed through the encoder.

The above is merely the implementation of the present disclosure. It should be noted that those of ordinary skill in the art may further make improvements without departing from the creative concept of the present application, and these improvements all fall within the protection scope of the present application.

1. A pulse penis, comprising:
a shell, provided with an accommodating cavity in a length direction thereof;
a first pulse assembly, comprising a first motor arranged in the accommodating cavity, and a first eccentric block and a second eccentric block that are arranged on two opposite sides of the first motor; and
a second pulse assembly, comprising a second motor arranged in the accommodating cavity and a third eccentric block arranged on the second motor, wherein the second motor is arranged behind the first motor in the length direction of the shell, and when the pulse penis is used, the first pulse assembly and the second pulse assembly operate alternately;
wherein an axis of the first motor and an axis of the second motor are located on a same straight line in the length direction of the shell.

2. The pulse penis according to claim 1, wherein the shell comprises a plurality of fixed blocks; and
the plurality of fixed blocks are arranged on an inner surface of the shell to enclose a first fixed groove and a second fixed groove, the first fixed groove and the second fixed groove are formed in a spaced manner in the length direction of the pulse penis, the first fixed groove fixes the first pulse assembly, and the second fixed groove fixes the second pulse assembly.

3. The pulse penis according to claim 2, wherein the shell further comprises a first division plate, the first division plate being arranged in the first fixed groove and dividing the first fixed groove into a first cavity and a second cavity;
one side of the first fixed groove close to a massage end and the shell enclose a third cavity, the first cavity, the second cavity, and the third cavity are parallelly formed in sequence, and the first motor is arranged in the second cavity.

4. The pulse penis according to claim 3, wherein the shell is further provided with a cable cavity, the plurality of fixed blocks and the shell enclosing the cable cavity; and
a first through slot is formed in a side wall of the first fixed groove, the first through slot communicates the second cavity with the cable cavity, and the cable cavity is configured to fix cables.

5. The pulse penis according to claim 4, wherein the shell is further provided with the cable cavity, the plurality of fixed blocks and the shell enclosing the cable cavity; and
the first through slot is formed in the side wall of the first fixed groove, the first through slot communicates the second cavity with the cable cavity, and the cable cavity is configured to fix the cables.

6. The pulse penis according to claim 1, wherein the shell comprises a holding portion and a stimulating portion arranged in sequence in the length direction thereof, and the pulse penis further comprises a connecting piece arranged between the holding portion and the stimulating portion; and
the connecting piece divides the accommodating cavity to form an electrical cavity and a vibrating cavity, the connecting piece is provided with a cable duct, the cable duct communicates the electrical cavity with the vibrating cavity, and the cable duct and the shell enclose a fixed channel to prevent cables from deviating.

7. The pulse penis according to claim 6, further comprising a power supply assembly, the power supply assembly being arranged in the electrical cavity and electrically connected to the first motor and the second motor to supply power to the pulse penis.

8. The pulse penis according to claim 7, wherein the shell further comprises a fixed base, the fixed base being arranged at a bottom of the electrical cavity and fixedly connected to the shell, and the power supply assembly being arranged on the fixed base.

9. The pulse penis according to claim 8, further comprising a control assembly, wherein
the control assembly comprises a control panel and a stepless adjusting device electrically connected to the control panel, the control panel being arranged on the fixed base and electrically connected to the power supply assembly; and
the stepless adjusting device is arranged on one side of the fixed base facing away from the control panel and is rotationally connected to the fixed base to adjust power of the first pulse assembly and the second pulse assembly.

10. The pulse penis according to claim 6, further comprising a heating film, the heating film being arranged at one end of the stimulating portion facing away from the holding portion to perform heating during use.
